(19) United States
(12) Patent Application Publication
(10) Pub. No.: US 2015/0088537 A1
(43) Pub. Date: Mar. 26, 2015

(54) SYSTEM AND METHOD FOR HEALTHCARE STOP-LOSS OR REINSURANCE ASSESSMENT AND PLANNING

(71) Applicant: ADVANCED MEDICAL STRATEGIES, LLC, Lynnfield, MA (US)

(72) Inventors: Peter BORANS, North Reading, MA (US); Stacy BORANS, Chalfont, PA (US)

(21) Appl. No.: 14/484,791

(22) Filed: Sep. 12, 2014

Related U.S. Application Data
(60) Provisional application No. 61/880,547, filed on Sep. 20, 2013.

(51) Int. Cl. G06Q 40/08; G06Q 30/02; G06Q 50/22; G06Q 40/00

(52) U.S. Cl. CPC G06Q 40/08; G06Q 50/22; G06Q 40/00; G06Q 30/0215
USPC 705/2

(57) ABSTRACT

A system and method for healthcare stop-loss or reinsurance assessment and planning comprising receiving input data, the input data comprising diagnosis data related to a medical condition; identifying data in a healthcare diagnosis/financial database (HDFD) based on, at least in part, the input data, the identified data comprising treatment data including a list of one or more treatments associated with the diagnosis data and expected treatment costs associated with each treatment of the list of one or more treatments, and procedure data comprising a list of one or more procedures associated with the diagnosis data and expected procedure costs associated with each treatment of the list of one or more treatments, generate output data based on, at least in part, the identified data; and transmitting the output data to a user.

### CROSS-REFERENCE TO RELATED APPLICATION

The present application claims priority to U.S. Provisional Application Ser. No. 61/880,547, filed on Sep. 20, 2013, the disclosure of which is incorporated herein by reference.

### FIELD

The present disclosure relates to the field of healthcare stop-loss or reinsurance assessment and planning.

### BACKGROUND

The number of businesses who are “self-insuring” has dramatically increased recently due, in part, to changes implemented by the Affordable Care Art. In particular, many companies have determined that it is more cost-effective to provide their employees with health insurance directly without having to pay for tradition group insurance plans. Companies may accomplish this by establishing a fund that it uses to pay the medical expenses of its workers and families. While this may be more cost effective and/or provide more flexibility, the “self-insuring” approach also increases the company's risk exposure. In particular, if the actual costs to provide the healthcare exceed the healthcare predictions and the fund set up to pay for healthcare (e.g., if an unexpectedly large number of employees get seriously ill), then the company may be exposed to potential lawsuits and potential bankruptcy.

One solution to protect and reduce the risk is for the company to purchase healthcare stop-loss or reinsurance policy. While many variations of healthcare stop-loss or reinsurance policies exist, such policies typically pay for employee's medical costs after the company has paid a predetermined amount. For example, some healthcare stop-loss or reinsurance policies begin making payments for a specific employee or employee family member after the company has paid a predetermined amount while other healthcare stop-loss or reinsurance policies begin making payments for after the company has paid a predetermined total amount.

Healthcare stop-loss or reinsurance companies may use many factors when determining policy costs, risk assessment, setting reserves. One factor which is of particular importance when determining policy costs, risk assessment, setting reserves includes catastrophic diagnoses. Catastrophic diagnoses represents includes serious medical diagnoses which may result in significant or large amounts of health care expenses over a short term (e.g., one year or less) and/or long term (e.g., over one year) which represent risks that should be carefully understood and managed.

Traditionally, underwriters have used educated guesswork and scanty data for calculating premiums, making estimated costs predictions, and setting reserves. Unfortunately, the lack of readily accessible data and lack of customizable data has reduced the efficiency and accuracy of these calculations. Accordingly, what is needed is a system and method for healthcare stop-loss or reinsurance assessment and planning which provides users with easily accessible and/or customizable data related to catastrophic diagnoses.

### BRIEF DESCRIPTION OF THE DRAWINGS

FIG. 1 depicts exemplary system architecture illustrating one or more client devices bi-directionally communicating with one or more network servers via network, consistent with non-limiting embodiments of the present disclosure.

FIG. 2 depicts an exemplary embodiment of a network server in accordance with non-limiting embodiments of the present disclosure.

FIG. 3 depicts an exemplary embodiment of a healthcare diagnosis/financial database in accordance with non-limiting embodiments of the present disclosure.

FIG. 4 depicts a flowchart of an exemplary method of providing healthcare diagnosis/financial data to a user at a client device using the network server, in accordance with non-limiting embodiments of the present disclosure.

FIGS. 5A-5D depict exemplary output data generated by the network server which may be transmitted to and received at a client device, in accordance with non-limiting embodiments of the present disclosure.

FIG. 6 depicts a flowchart of an exemplary method of obtaining data at a client device to generate a stop-loss re-insurance policy premium and/or treatment audit using the network server, in accordance with non-limiting embodiments of the present disclosure.

### DETAILED DESCRIPTION

By way of a brief overview, one embodiment of the present disclosure includes systems and methods for healthcare stop-loss or reinsurance assessment and planning. The systems and methods include a healthcare diagnosis/financial database, a healthcare diagnosis search module, and optionally clinical filtering module. The healthcare diagnosis/financial database includes data related to catastrophic diagnoses which may be useful in determining policy costs, risk assessment, and/or setting reserves includes catastrophic diagnoses. The healthcare diagnosis search module and/or clinical filtering module are configured to receive input data from an authorized client device and search and/or identify potentially relevant data from the healthcare diagnosis/financial database based, at least in part, on the input data.

The input data may include any data useful to identify a medical condition contained in the healthcare diagnosis/financial database (such as, but not limited to, diagnosis data and/or patient data. Diagnosis data may include, but is not limited to, diagnosis codes such as the International Classification of Diseases (ICD) codes published by the World Health Organization (WHO), medical diseases/syndromes, medical signs, medical symptoms, abnormal medical findings, medical complaints, social circumstances, and the like. Patient data may include, but is not limited to, patient age, patient sex, clinical data, location, other medical conditions, genetics, and the like.

The output data identified from the healthcare diagnosis/financial database may include diagnosis data and/or estimated expected treatment costs associated with the identified medical condition. For example, the diagnosis data may include a commonly accepted name of the identified medical condition, one or more medical codes (e.g., IDS code), patient data (e.g., age, sex, etc.), typical or generally accepted medical treatment options, and prognosis data. The expected treatment cost information may include national and/or local expected treatment cost information. The output data from the healthcare diagnosis search module may be used, at least in part, to generate stop-loss reinsurance policy premiums and/or to analyze, compare, and/or audit a submitted bill.

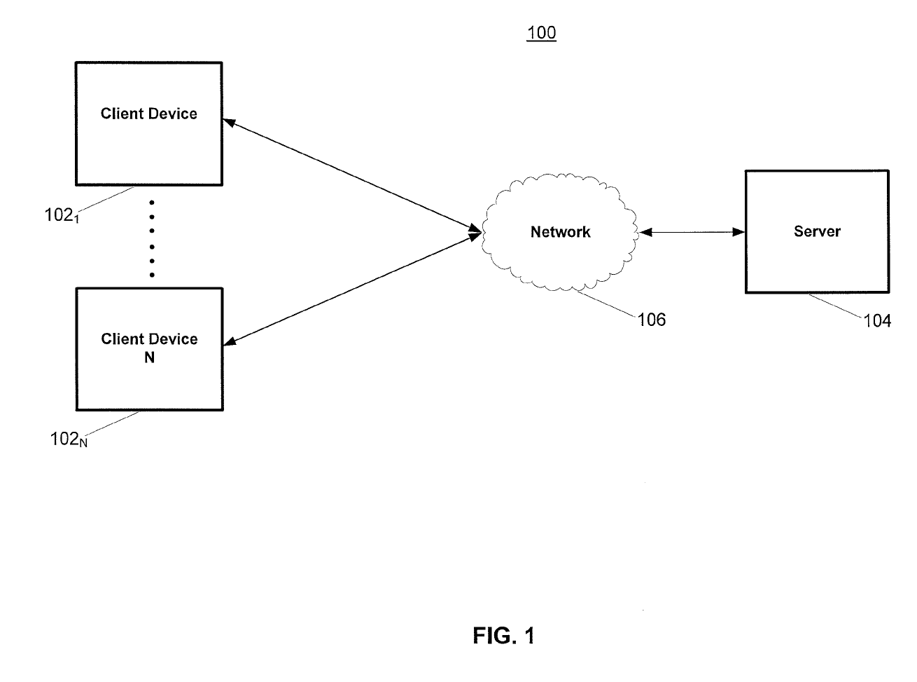

Turning now to FIG. 1, one embodiment of an exemplary system architecture 100 in accordance with non-limiting embodiments of the present disclosure is generally illustrated. As shown, system 100 includes one or more client devices 102₁-102ₙ (individually referred to as a client device 102) and network server 104. Non-limiting examples client devices 102 include mobile devices (such as but not limited to cell phones, electronic readers, handheld game consoles, mobile internet devices, portable media players, personal digital assistants, smart phones, tablet personal computers, ultra-mobile personal computers, netbooks, and notebook computers) as well as desktop computers, kiosks, and public computer terminals.

Client devices 102₁-102ₙ and network server 104 may bi-directionally communicate with one another via network 106. As described herein in more detail, a user may transmit data from a client device 102 via the network 106 to the network server 104. The network server 104 may generate a result which is transmitted via the network 106 to the client device 102. Network 106 may be any network that carries data. As examples of suitable networks that may be used as network 106 in accordance with the present disclosure, non-limiting mention is made of the internet (also referred to herein as the “cloud”), private networks (e.g., a local area network), virtual private networks (VPN), public switch telephone networks (PSTN), integrated services digital networks (ISDN), digital subscriber link networks (DSL), wireless data networks (e.g., cellular phone networks, wireless local area networks, and the like), combinations thereof, and other networks capable of carrying data. In some non-limiting embodiments, network 106 includes at least one of the internet, a local area network, a wireless local area network, a cellular telephone network, and combinations thereof.

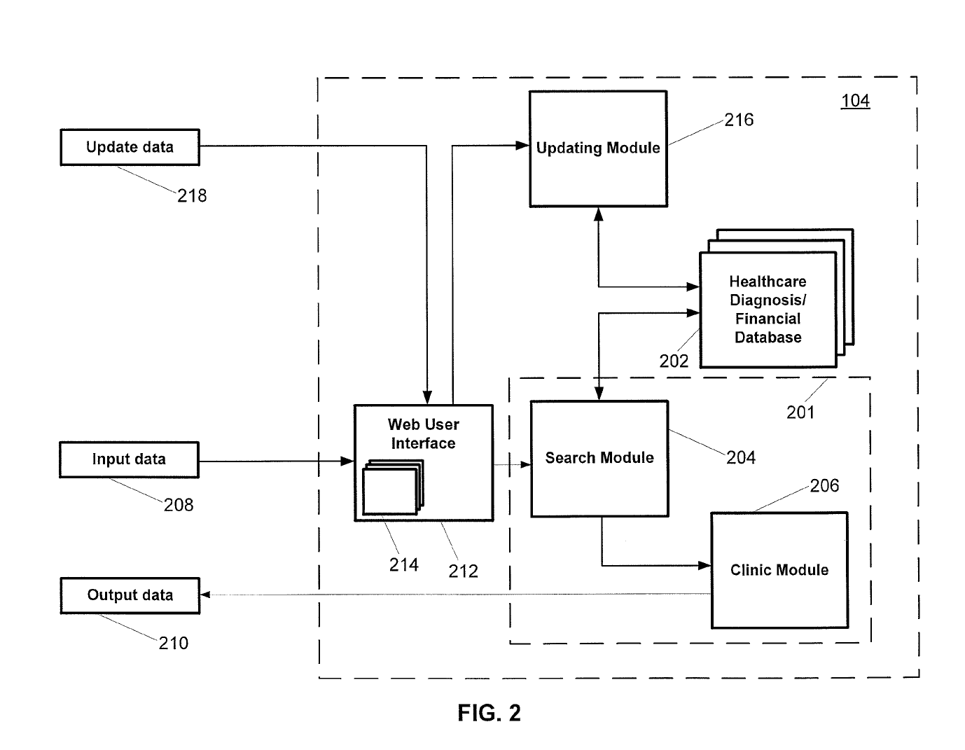

With reference to FIG. 2, one embodiment of an exemplary network server 104 in accordance with non-limiting embodiments of the present disclosure is generally illustrated. For purposes of clarity, the network server 104 is illustrated as a single server machine; however, it should be appreciated that the network server 104 may include a plurality of server machines, which may be co-located or distributed geographically. Additionally, while not illustrated for clarity, network server 104 includes one or more host processors which may execute software, such as but not limited to operating system (OS), modules, and/or applications. Network server 104 also includes chipset circuitry which may include one or more integrated circuit chips. “Circuitry”, as used in any embodiment herein, may comprise, for example, singly or in any combination, hardwired circuitry, programmable circuitry, state machine circuitry, and/or firmware that stores instructions executed by programmable circuitry.

In operation, network server 104 may store a copy or portion of a copy of a healthcare diagnosis/financial database “HDFD” 202. As described in more detail herein, the HDFD 202 includes data related to catastrophic diagnoses which may be useful in determining policy costs, risk assessment, and/or setting reserves includes catastrophic diagnoses. As used herein, a “catastrophic diagnosis” means includes a serious medical diagnosis which may result in significant or large amounts of health care expenses over a short term (e.g., one year or less) and/or long term (e.g., over one year) which represent risks that should be carefully understood and managed.

Network server 104 may also include one or more modules. For example, network server 104 may include a healthcare diagnosis module 201. The healthcare diagnosis module 201 may include a healthcare diagnosis search module “HDSM” 204 and optionally clinical filtering module “CFM” 206. The HDSM 204 and/or CFM 206 are configured to receive input data 208 from an authorized client device 102 and search and/or identify potentially relevant data from the HDFD 202 based, at least in part, on the input data 208. The input data 208 may include any data useful to identify a medical condition contained in the HDFD 202. Non-limiting examples of input data 208 may include diagnosis data (e.g., but is not limited to, diagnosis codes such as the International Classification of Diseases (ICD) codes published by the World Health Organization (WHO), medical diseases/syndromes, medical signs, medical symptoms, abnormal medical findings, medical complaints, social circumstances, and the like). The input data 208 may optionally include patient data (e.g., but is not limited to, patient age, patient sex, clinical data, location, other medical conditions, genetics, and the like). As explained herein, the potentially relevant output data 210 which may be identified from the HDFD 202 is transmitted to the client device 102. The input data 208 may include, for example, the selection of one or more menus (e.g., but not limited to, drop down boxes) and/or entering data (e.g., but not limited to, typing data).

Network server 104 may further include at least one user interface module “UIM” (e.g., a web user interface) 212. The IUM 212 is configured to receive and verify authentication information from the client device 102 such that only authorized client devices 102 and/or authorized users may gain access to the network server 104. The IUM 212 may include a plurality of user profiles 214. The user profiles 214 contain information used to verify the user's identity, the client device 102, and/or limit access to the network server 104. For example, the user profiles 214 may keep track of and/or limit how many times the user has accessed the network server, which portions of the network server 104 that the user may access, how much data that the user may download, and the like.

The network server 104 may optionally include an updating module “UM” 216. The UM 216 is configured to allow an administrator or authorized user (e.g., but not limited to, a third party vendor) modify or update selected portions of the network server 104. For example, UM 216 is configured to allow an administrator or authorized user to upload update data 218 to the network server 104. The UM 216 may be configured to grant different rights to different users. For example, the UM 216 may allow the administrator to modify/update any portion of the network server 104 (e.g., data in the HDFD 202, the HDSM 204, CFM 206, or the UI 212) while only allowing specific third party vendors to update/modify selected portions of the data contained in the HDFD 202.

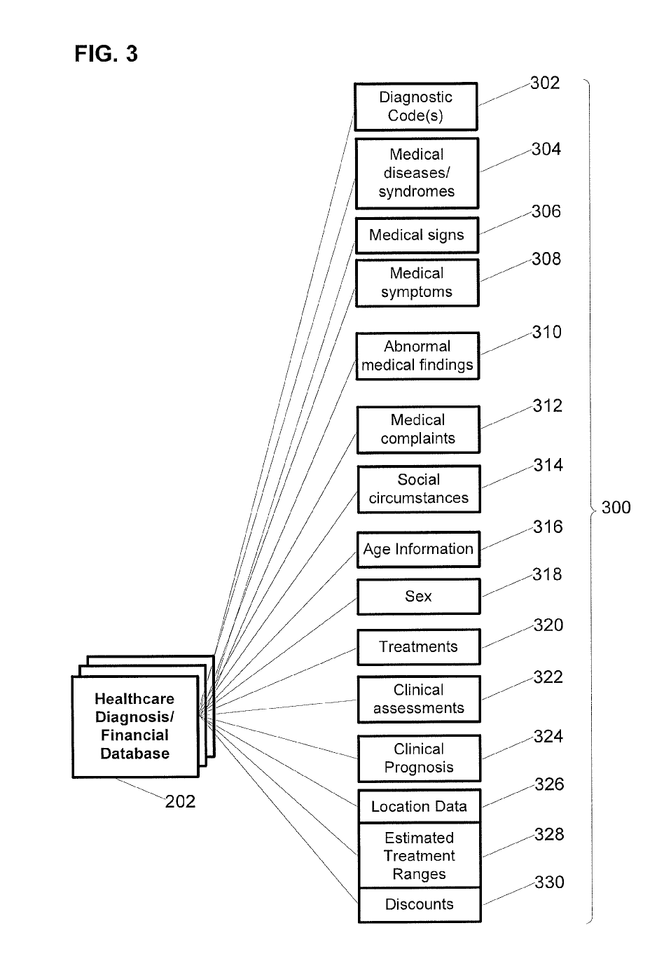

With reference to FIG. 3, one embodiment of an exemplary HDFD 202 in accordance with non-limiting embodiments of the present disclosure is generally illustrated. The HDFD 202 may include data 300 such as, but not limited to, data related to and/or representing diagnosis codes 302 (e.g., ICD codes), medical diseases/syndromes 304, medical signs 306, medical symptoms 308, abnormal medical findings 310, medical complaints 312, social circumstances 314, age information 316 (e.g., actual age, age ranges, and/or age classifications such as, but not limited to, infant, child, teenager, adult, elderly, etc.), patient sex 318, medical treatments 320 (such as, but not limited to, generally accepted or proven medical treatments (e.g., approved by the U.S. Food and Drug Administration), experimental treatments, investigative treatments, alternative treatments), clinical assessments 322, clinical prognosis 324, location data 326 (e.g., regional, local, and/or national), estimated expected treatment costs 328, discounts 330 (e.g., regional, local, hospital, and/or national), and the like. The estimated treatment costs 328 may include, but are not limited to, estimated billed amounts, estimated paid amounts, and/or historical data (e.g., by diagnosis code) of costs information for some number of claims (e.g., the last X number of claims) received, billed, and/or paid, and optionally including location data (e.g., state). The medical diseases/syndromes 303 may include diagnosis descriptions which can be correlated to diagnosis codes 302. The medical diseases/syndromes 303 may optionally include one or more related diagnosis codes 302 commonly associated with an initial diagnosis code 302.

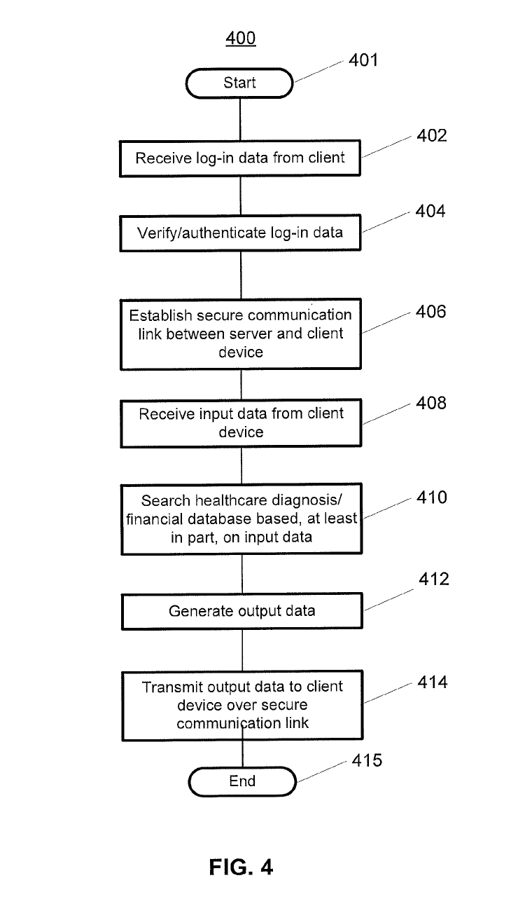

Turning now to FIG. 4, a non-limiting example of a method 400 of providing data to a user at a client device 102 using the network server 104 is generally illustrated. The method starts at block 401. At block 402, log-in data that has been transmitted from a client device 102 is received at the network server 104 via the network 106. The log-in data may include a user identification and password which may be received by the UI 212. At block 404, the UI 212 may verify and/or authenticate the log-in data, for example, by comparing it with the user profiles 214. At block 406, after verification and/or authentication, a secure communication link may optionally be established between the client device 102 and the network server 104 across the network 106. The UI 212 may restrict access to data 300 in the HDFD 202 based on previous use of the network server 104 and the user's account limitations.

At block 408, the network server 104 receives input data 208 from the client device 102. The input data 208 may include any information/data useful to identify a medical condition contained in the HDFD 202. For example, the input data 208 may include diagnosis data (e.g., but is not limited to, diagnosis codes such as ICD codes, medical diseases/syndromes, medical signs, medical symptoms, abnormal medical findings, medical complaints, social circumstances, and the like) and/or patient data (e.g., but is not limited to, patient age, patient sex, clinical data, location, other medical conditions, genetics, and the like)

At block 410, the healthcare diagnosis module 201 may search the HDFD 202 based, at least in part, on the input data 208 to identify relevant data in the HDFD 202. For example, the HDSM 204 may search the HDFD 202 using the input data 208 (e.g., the diagnosis data) to identify one or more medical conditions as well as medical treatment(s) associated with the identified medical condition(s), clinical assessments associated with the identified medical condition(s), prognosis data associated with the identified medical condition(s), and/or estimated expected treatment costs associated with the identified medical condition(s). By way of a non-limiting example, the HDSM 204 may use the ICD code associated with a medical condition to identify medical treatment(s), clinical assessments, prognosis, and/or estimated expected treatment costs associated with the ICD code medical condition.

Optionally, the CFM 206 may further customize and/or individualize the results of the search of the HDFD 202, for example, based on input data 208. For example, the CFM 206 may utilize the patient data (e.g., patient age, patient sex, clinical data, location, other medical conditions, genetics, etc.) to further specify the medical treatment(s), clinical assessments, prognosis data, and/or estimated expected treatment costs. By way of non-limiting examples, the CFM 206 may modify the estimated expected treatment costs and/or prognosis data based on the patient's location, age, sex, clinical data, and/or medical conditions. For example, the CFM 206 may adjust/modify estimated expected treatment costs in the HDFD 202 taking into consideration discounts based on the patient's location (e.g., regional discounts, and/or local discounts such as hospital specific discounts). The CFM 206 may adjust/modify estimated expected treatment costs in the HDFD 202 taking into consideration the patient's clinical data and/or other medical conditions. The CFM 206 may adjust/modify the medical treatments and/or prognosis data based on the patient's age, sex, clinical data, and/or other medical conditions. It may therefore be appreciated that the CFM 206 may customize and/or individualize the results of the search of the HDFD 202 based on how much and the type of input data 208 provided by the client device 102.

At block 412, an output data is generated, for example, by the healthcare diagnosis module 201. The output may include the data identified from the search of the HDFD 202 as well as additional data. The additional data may include, for example, some or all of the input data 208. At block 414, the network server 104 transmits the output data to the client device 102, for example, over the secure communication link. The user may provide additional input data 208 to the network server 104, and the method 400 may repeat as necessary. The method then ends at block 415.

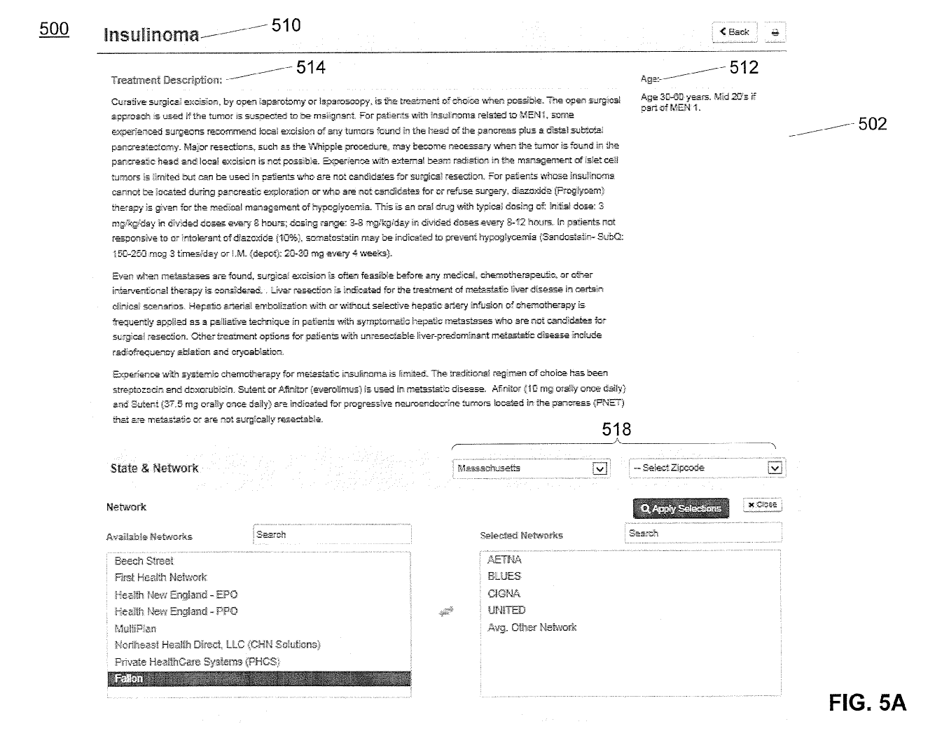

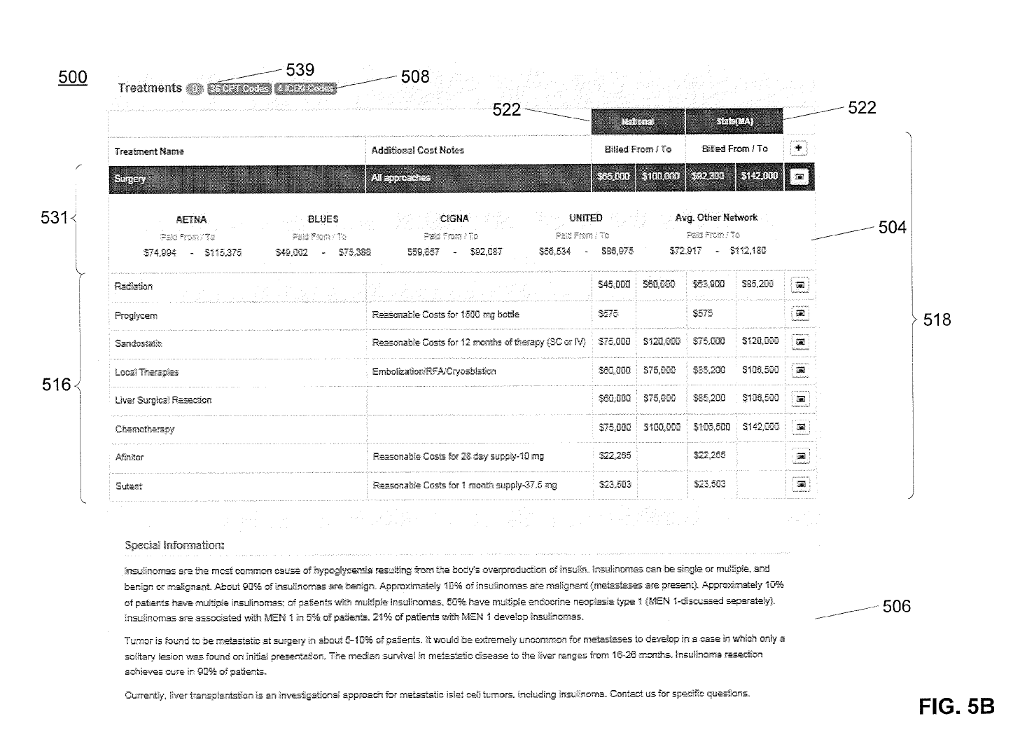

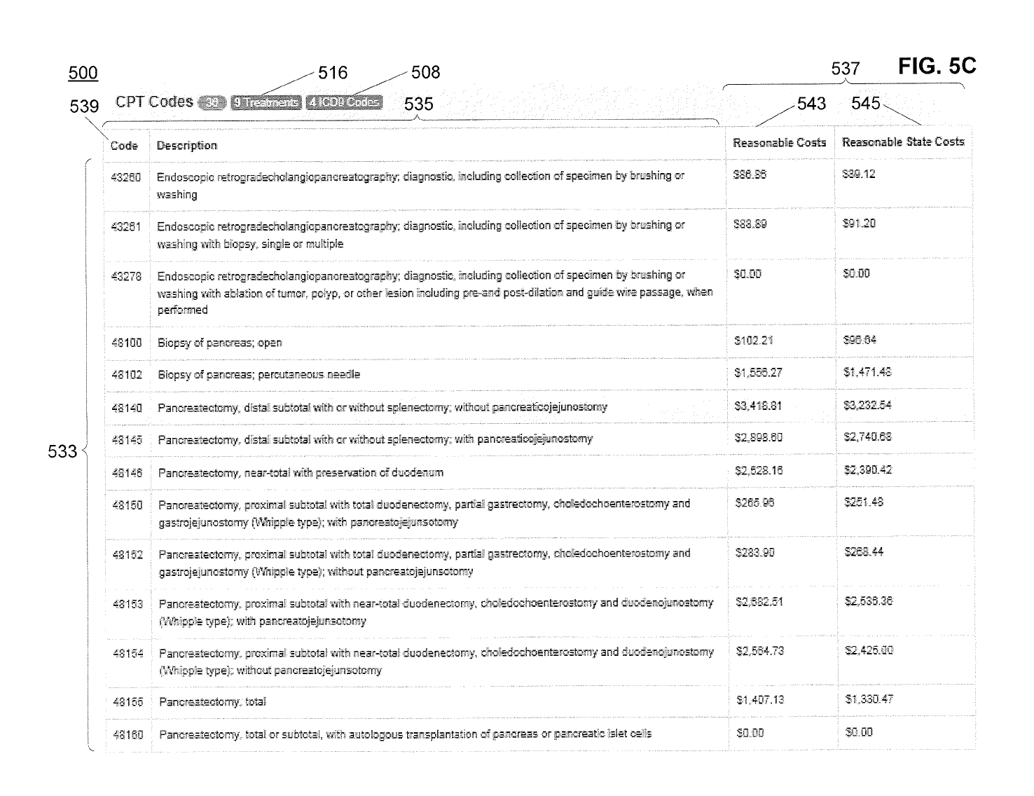

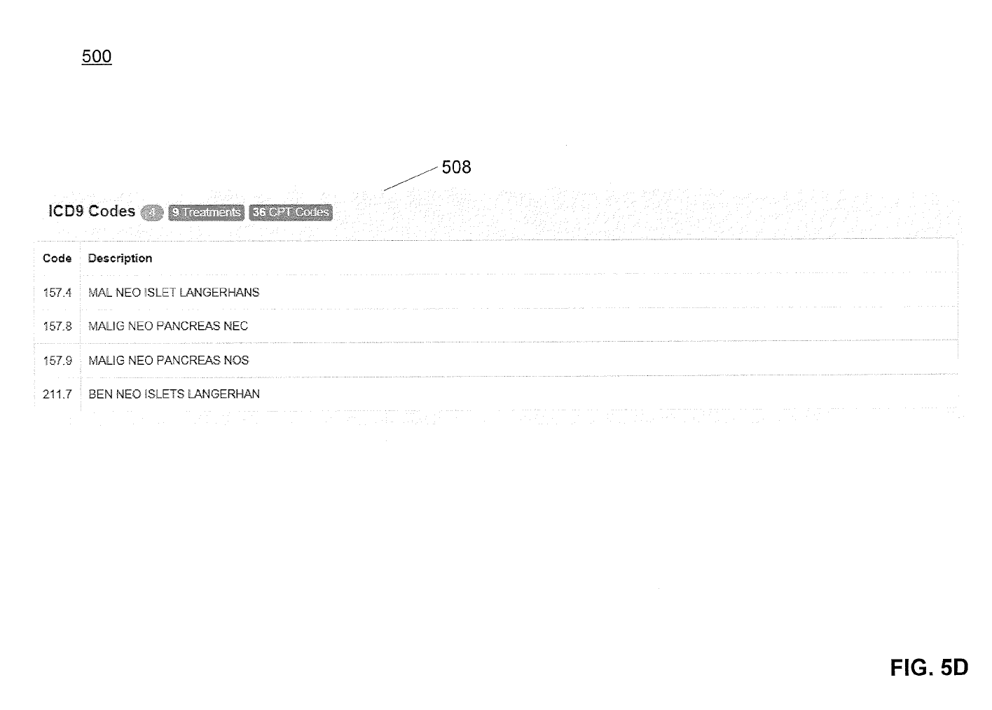

Turning now to FIGS. 5A-5D, a non-limiting example of an exemplary output data 500 generated by the network server 104 which may be transmitted to and received at a client device 102 is generally illustrated. The output data 500 may include diagnosis data 502 (FIG. 5A), estimated expected treatment costs 504 (FIG. 5A) associated with the identified medical condition, special information 506 (FIG. 5B), estimated expected procedure costs 509 (FIG. 5C), and/or related medical conditions 508 (FIG. 5D). By way of non-limiting example, the diagnosis data 502 may include an identified/commonly accepted name of the medical condition 510 (e.g., associated with one or more medical codes such as an ICD code), patient data 512 (e.g., age, sex, etc.), and typical or generally accepted medical treatment options 514. As used herein, typical and/or approved medical treatments 514 may include any drugs, surgical procedures, local therapies, or the like that are used to treat a given disease/diagnosis and may be based on one or more accepted medical guidelines such as, but not limited to, standard of care guidelines such as the National Comprehensive Cancer Network (NCCN) other educational websites such as National Cancer Institute (NCI), Medscape, The Journal of the American Medical Association (JAMA), The New England Journal of Medicine (NEJM), U.S. Food and Drug Administration (USFDA), and/or other peer reviewed literature.

By way of non-limiting example, the estimated expected treatment costs 504 associated with the identified medical condition may include a listing 516 of the typical or approved medical treatment options 514 and expected treatment cost information 518 associated with each medical treatment option 514 in the listing 518. As may be seen, the listing 516 of medical treatment options includes the typical or generally accepted medical treatment options 514 and may optionally include one or more additional treatment options which are potential alternative secondary options.

The expected treatment cost information 518 associated with each medical treatment option 514 in the listing 516 may include national expected treatment cost information 520 and/or may include customized, adjusted, and/or filtered expected treatment cost information 522. The national expected treatment cost information 520 may include a cost amount and/or a cost range of national expected treatment cost information which is based on real-world costs. The customized, adjusted, and/or filtered expected treatment cost information 522 may include a cost amount and/or cost range which takes into consideration patient data. By way of a non-limiting example, the customized, adjusted, and/or filtered expected treatment cost information 522 may include local cost information. The local cost information may be based on regional and/or local geographical data 519 (e.g., the local cost information may take into consideration which state, zip code, and/or whether the patient will be having treatment in the northeast, Massachusetts, greater Boston area, specific hospital or hospital system, and/or insurance provider). The customized, adjusted, and/or filtered expected treatment cost information 522 may also include discount information (e.g., which may be based on the patient's geography and/or other medical conditions).

Additionally, the user may select one or more networks and/or preferred provider organization (PPO) for which he/she is interested in obtaining estimated expected treatment costs 504. For example, the user may enter geographical data 519 (e.g., but not limited to, a state and/or a zip code) as described above. Based on the entered geographical data, a listing 523 of available networks and/or PPOs may be provided to the user. The listing 523 of available networks and/or PPOs may also include an Average Other Networks 531 in order to provide the user with additional information regarding how the costs associated with the other selected networks and/or PPOs compare to the average of the other networks.

The user may then select one or more networks and/or PPOs which are of interest 525 from the listing 523 of available networks and/or PPOs. The user may optionally enter a search term 527 to identify one or more networks and/or PPOs from the listing 523. The selected networks and/or PPOs are then shown in a listing of networks and/or PPOs 529. The estimated expected treatment costs 504 may include estimated expected treatment costs 531 for the listing of selected networks and/or PPOs 529 which are of interest. For example, the estimated expected treatment costs 531 may include an estimated, expected cost and/or range of estimated, expected costs for each of the selected networks and/or PPOs in the listing 529.

Again, it should be appreciated that the output data 500 illustrated in FIGS. 5A-5C is merely one example consistent with the present disclosure. The format and content of the data provided by the network server 104 will depend on the input data 208 provided to the network server 104 by the user at the client device 102. As such, the output data 500 may not always include all of the information illustrated in FIGS. 5A-5C and/or may include additional or alternative information.

The special information section/description 506 may include ancillary information corresponding to the input data or diagnosis data and helpful/useful in looking at (i.e., related to) potential complications, prognosis, potential experimental therapies, new treatments on the horizon (i.e., new potential upcoming treatments) and/or any other clinical references that may be useful for the client/user. The prognosis data may include information related to how the expected treatment costs and/or expected procedure costs (e.g., costs) could increase (e.g., but not limited to, information regarding possible complications which could increase the treatment costs and/or procedure costs).

Turning now to FIG. 5C, one embodiment of the estimated expected procedure costs 509 is generally illustrated. The estimated expected procedure costs 509 may include a listing 533 of the most commonly performed procedures 535 associated with a given diagnosis (e.g., ICD9 codes 508) and/or listing of treatments 516, along with estimated, expected procedure costs 537 associated with each of the identified procedures 535. The listing 533 of procedures 535 may include a code 539 (e.g., but not limited to, Current Procedural Terminology (CPT) codes maintained by the American Medical Association through the CPT Editorial Panel) and/or a description 541 for each of the identified procedures 535.

The estimated, expected procedure costs 537 associated with each of the identified procedures 535 may include average reasonable costs 543 and/or national expected procedure cost information 543 and/or may optionally include customized, adjusted, and/or filtered expected procedure cost information 545. The national expected procedure cost information 543 may include a cost amount and/or a cost range of national expected procedure cost information which is based on real-world costs. The customized, adjusted, and/or filtered expected procedure cost information 545 may include a cost amount and/or cost range which takes into consideration patient data. By way of a non-limiting example, the customized, adjusted, and/or filtered expected procedure cost information 545 may include local cost information. The local cost information may be based on regional and/or local geographical data 519 as described herein (e.g., the local cost information may take into consideration which state, zip code, and/or whether the patient will be having treatment in the northeast, Massachusetts, greater Boston area, specific hospital or hospital system, and/or insurance provider). The customized, adjusted, and/or filtered expected procedure cost information 545 may also include discount information (e.g., which may be based on the patient's geography and/or other medical conditions).

Turning now to FIG. 5D, the related medical conditions 508 section may include information regarding medical conditions associated with the medical condition 510 being reviewed. For example, the related medical conditions 508 section may include links to other output data 500, for example, using ICD9 codes or the like. For example, the special information 506 and the related medical conditions 508 may be useful with assessing a potential laser on a patient as well as claims costs for an ongoing case, for example, during the upcoming 12 months.

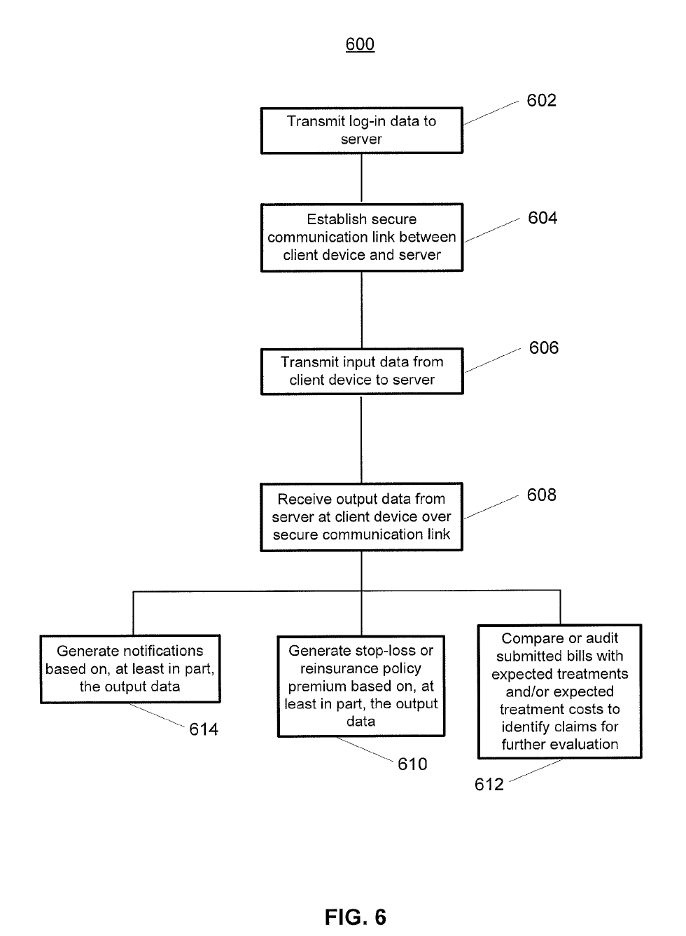

With reference to FIG. 6, a non-limiting example of a method 600 of obtaining data at a client device 102 to generate a stop-loss re-insurance policy premium and/or treatment audit using the network server 104 is generally illustrated. At block 602, the method 600 includes transmitting log-in data from the client device 102 to the network server 104 across network 106. Optionally, a secure communication link may be established between the client device 102 and the network server 104 at block 604. After the network server 104 verifies and/or authenticates the user and/or client device 102, the user transmits input data 208 from the client device 102 to the network server 104 at block 606. The user may provide only data necessary to identify the medical condition (e.g., but not limited to, the ICD code and/or medically defined name or classification of the medical condition). The user may also provide patient data (e.g., but not limited to, the patient's age, sex, medical condition, and/or clinical data). Upon receipt of the input data 208, the network server may search the HDFD 202 to identify potentially relevant information related to the input data 208 (e.g., diagnosis data and/or estimated expected treatment costs associated with the identified medical condition).

At block 608, the client device 102 may receive output data from the network server 104, for example, across the secure communication link. An example of the output data received at the client device 102 may include the output data 500 (FIG. 5). The data received from the network server 104 may be used, at least in part, to generate stop-loss reinsurance policy premiums, block 610. By way of non-limiting example, the data 500 received from the network server 104 may be used to identify individual(s) that are likely to result in higher treatment costs. Based, at least in part, on the expected treatment costs, the user may utilize the data 500 to calculate/adjust premiums for either the group and/or for an individual in the group.

At block 612, the data received from the network server 104 may be used, at least in part, to analyze, compare, and/or audit a submitted bill. By way of non-limiting example, the actual and/or to be performed medical treatments and/or costs may be compared with a listing 516 of the typical or approved medical treatment options 514 and/or the estimated expected treatment costs associated with the identified medical condition. Actual and/or to be performed medical treatments which are not included in the listing 516 of the typical or approved medical treatment options 514 may be rejected and/or flagged for further examination/investigation. Additionally (or alternatively), the costs associated with actual and/or to be performed medical treatments may be compared with the estimated expected treatment costs 504 associated with the identified medical condition to determine if the are appropriate. For example, costs associated with actual and/or to be performed medical treatments which do not fall within the range of estimated expected treatment costs associated with the identified medical condition may be rejected and/or flagged for further examination/investigation.

At block 614, the data received from the network server 104 may be used, at least in part, to generate one or more notifications. By way of non-limiting example, the output data 500 may be used to generate reservation notifications, cost containment notifications, and/or management opportunity notifications. Notification may be generated, for example, upon a diagnosis code (e.g., ICD code) being entered, for example, into the network server 104 and/or the user's system.

The user of the network server 104 may include, but is not limited to, insurance companies, worker compensation agencies, third party insurance administers, stop loss companies, Taft Hartley plans, and the like.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination as would be understood by one skilled in the art. Thus, not all of the operations of each of the flowcharts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk re-writables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry,” as used in any embodiment herein, may comprise, for example, singly or in any combination, hardwired circuitry, programmable circuitry, state machine circuitry, and/or firmware that stores instructions executed by programmable circuitry. An app may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Other embodiments of the present disclosure will be apparent to those skilled in the art from consideration of the specification and practice of the inventions disclosed herein. It is intended that the specification be considered as exemplary only, with a true scope and spirit of the invention being indicated by the following claims.

What is claimed is:

1. A system comprising:
at least one processor;
at least one memory coupled to said processor, said at least one memory comprising a healthcare diagnosis/financial database (HDFD);
a healthcare diagnosis module configured to:
receive input data, said input data comprising diagnosis data related to a medical condition;
identify data in said HDFD based on, at least in part, said input data, said identified data comprising:
treatment data comprising a list of one or more treatments associated with said diagnosis data and expected treatment costs associated with each treatment of said list of one or more treatments; and
procedure data comprising a list of one or more procedures associated with said diagnosis data and expected procedure costs associated with each procedure of said list of one or more procedure; and
generate output data based on, at least in part, said identified data; and
transmit said output data to a user.

2. The system of claim 1, wherein said input data further comprises geographical data, and wherein at least one of said expected treatment costs or said expected procedure costs associated with each treatment of said list of one or more treatments is based, at least in part, on said geographical data.

3. The system of claim 2, wherein said geographical data includes at least one of a state or a zip code.

4. The system of claim 1, wherein said input data further comprises at least one selected network or preferred provider organization (PPO) of interest, and wherein at least one of said expected treatment costs or said expected procedure costs associated with each treatment of said list of one or more treatments is based, at least in part, on said selected network or PPO of interest.

5. The system of claim 4, wherein at least one of said expected treatment costs or said expected procedure costs is based, at least in part, on a discount associated with said selected network or PPO of interest.

6. The system of claim 1, wherein said diagnosis data comprises at least one International Classification of Diseases (ICD) code.

7. The system of claim 6, wherein said input data comprises patient data.

8. The system of claim 7, wherein said patient data comprises at least one of patient age, patient sex, clinical data, location, or other medical conditions.

9. The system of claim 1, wherein each of list of said procedures corresponds to a Current Procedural Terminology (CPT) code.

10. The system of claim 1, wherein said identified data further comprises a special information description comprising information corresponding to the input data and related to at least one of potential complications, prognosis, potential experimental therapies, new treatments on the horizon.

11. The system of claim 10, wherein said prognosis data includes information related to how the expected treatment costs and/or expected procedure costs could increase.

12. A method comprising:
receiving input data, said input data comprising diagnosis data related to a medical condition;
identifying data in a healthcare diagnosis/financial database (HDFD) based on, at least in part, said input data, said identified data comprising:
treatment data comprising a list of one or more treatments associated with said diagnosis data and expected treatment costs associated with each treatment of said list of one or more treatments; and
procedure data comprising a list of one or more procedures associated with said diagnosis data and expected procedure costs associated with each procedure of said list of one or more procedure; and
generate output data based on, at least in part, said identified data; and
transmitting said output data to a user.

13. The method of claim 12, wherein said input data further comprises geographical data, and wherein at least one of said expected treatment costs or said expected procedure costs associated with each treatment of said list of one or more treatments is based, at least in part, on said geographical data.

14. The method of claim 13, wherein said geographical data includes at least one of a state or a zip code.

15. The method of claim 12, wherein said input data further comprises at least one selected network or preferred provider organization (PPO) of interest, and wherein at least one of said expected treatment costs or said expected procedure costs associated with each treatment of said list of one or more treatments is based, at least in part, on said selected network or PPO of interest.

16. The method of claim 15, wherein at least one of said expected treatment costs or said expected procedure costs is based, at least in part, on a discount associated with said selected network or PPO of interest.

17. The method of claim 12, wherein said input data comprises patient data, said patient data comprising at least one of patient age, patient sex, clinical data, location, or other medical conditions.

18. The method of claim 12, wherein said identified data further comprises a special information description comprising information corresponding to the input data or diagnosis data and related to at least one of potential complications, prognosis, potential experimental therapies, new treatments on the horizon.

19. The method of claim 18, wherein said prognosis data includes information related to how the expected treatment costs and/or expected procedure costs could increase.

20. A system comprising one or more non-transitory storage mediums having stored thereon, individually or in combination, instructions that when executed by one or more processors result in the following operations comprising:
receiving input data, said input data comprising diagnosis data related to a medical condition;
identifying data in a healthcare diagnosis/financial database (HDFD) based on, at least in part, said input data, said identified data comprising:
treatment data comprising a list of one or more treatments associated with said diagnosis data and expected treatment costs associated with each treatment of said list of one or more treatments; and
procedure data comprising a list of one or more procedures associated with said diagnosis data and expected procedure costs associated with each procedure of said list of one or more procedure; and
generate output data based on, at least in part, said identified data; and
transmitting said output data to a user.

21. The system of claim 20, wherein said input data further comprises geographical data, and wherein at least one of said expected treatment costs or said expected procedure costs associated with each treatment of said list of one or more treatments is based, at least in part, on said geographical data.

22. The system of claim 21, wherein said geographical data includes at least one of a state or a zip code.

23. The system of claim 20, wherein said input data further comprises at least one selected network or preferred provider organization (PPO) of interest, and wherein at least one of said expected treatment costs or said expected procedure costs associated with each treatment of said list of one or more treatments is based, at least in part, on said selected network or PPO of interest.

24. The system of claim 23, wherein at least one of said expected treatment costs or said expected procedure costs is based, at least in part, on a discount associated with said selected network or PPO of interest.

25. The system of claim 20, wherein said input data comprises patient data, said patient data comprising at least one of patient age, patient sex, clinical data, location, or other medical conditions.

26. The system of claim 20, wherein said identified data further comprises a special information description comprising information corresponding to the input data or diagnosis data and related to at least one of potential complications, prognosis, potential experimental therapies, new treatments on the horizon.

27. The system of claim 26, wherein said prognosis data includes information related to how the expected treatment costs and/or expected procedure costs could increase.

28. A system comprising:
means to receive input data, said input data comprising diagnosis data related to a medical condition;
means to identify data in a healthcare diagnosis/financial database (HDFD) based on, at least in part, said input data, said identified data comprising:
treatment data comprising a list of one or more treatments associated with said diagnosis data and expected treatment costs associated with each treatment of said list of one or more treatments; and
procedure data comprising a list of one or more procedures associated with said diagnosis data and expected procedure costs associated with each procedure of said list of one or more procedure; and
means to generate output data based on, at least in part, said identified data; and
means to transmit said output data to a user.

29. The system of claim 28, wherein said input data further comprises geographical data, and wherein at least one of said expected treatment costs or said expected procedure costs associated with each treatment of said list of one or more treatments is based, at least in part, on said geographical data.

30. The system of claim 29, wherein said geographical data includes at least one of a state or a zip code.

31. The system of claim 28, wherein said input data further comprises at least one selected network or preferred provider organization (PPO) of interest, and wherein at least one of said expected treatment costs or said expected procedure costs associated with each treatment of said list of one or more treatments is based, at least in part, on said selected network or PPO of interest.

32. The system of claim 31, wherein at least one of said expected treatment costs or said expected procedure costs is based, at least in part, on a discount associated with said selected network or PPO of interest.

33. The system of claim 28, wherein said diagnosis data comprises at least one International Classification of Diseases (ICD) code.

34. The system of claim 33, wherein said input data comprises patient data.

35. The system of claim 34, wherein said patient data comprises at least one of patient age, patient sex, clinical data, location, or other medical conditions.

36. The system of claim 28, wherein each of list of said procedures corresponds to a Current Procedural Terminology (CPT) code.

37. The system of claim 28, wherein said identified data further comprises a special information description comprising information corresponding to the input data and related to at least one of potential complications, prognosis, potential experimental therapies, new treatments on the horizon.

38. The system of claim 37, wherein said prognosis data includes information related to how the expected treatment costs and/or expected procedure costs could increase.
